(19) United States
(12) Patent Application Publication
(10) Pub. No.: US 2004/0109692 A1
(43) Pub. Date: Jun. 10, 2004

(54) FSO communication systems having high performance detectors

(76) Inventor: James Plante, San Diego, CA (US)

Correspondence Address: Joseph Page, Page Lohr Associates, P.O. Box 757, La Jolla, CA, 92038, US

(21) Appl. No.: 10/315,671

(22) Filed: Dec. 9, 2002

(51) Int. Cl. H04B 10/00

(52) U.S. Cl. 398/118; 398/130

(57) ABSTRACT

Free space optical communications systems operable at elevated temperatures include a special highly sensitive, low noise LWIR detector. The optical train is terminated at a special detector arrangement where a semiconductor photodetector and optical immersion type lens are combined and highly integrated as a single element. The detector active region is much smaller than comparable devices which affords a low noise factor critical in IR systems to be operated at high temperature.

### BACKGROUND OF THESE INVENTIONS

1. Field

The field of these inventions is characterized as wireless communications links and specifically as free space optical communications links having high performance IR detectors.

2. Prior Art

Free space optical communications systems have recently come to life as great demand for bandwidth drives advancement of this technology. In particular, these systems employ the infrared (IR) spectral band as a carrier. Some IR semiconductor lasers are inexpensive and their use is generally unregulated. The radiation they emit tends to be quite safe. In addition, other related optical components are also becoming inexpensive and readily available. Because of these reasons, free space optical (FSO) communications links employing the IR spectrum for a carrier have enjoyed measured success.

Although the future of FSO systems is quite promising, it is not without serious problems and limitations. Where optical communications links are used in the atmosphere, special considerations must be made for traversing problems relating to atmospheric attenuation. Presently, diode lasers are used to generate modulated beams of between about 0.7 and 1.6 microns in wavelength; sometimes known as ‘near’ infrared wavelengths. Energy at these wavelengths is highly susceptible to attenuation by scattering and absorption from water particles and vapor in the atmosphere. In particular, FSO systems based on near infrared wavelengths suffer nearly complete failure in even moderate fog. Even light fog has a strong adverse effect on optical communications links of 1.55 micron. Fog is responsible for a very high attenuation factor with regard to near infrared wavelengths. In light fog, attenuation can be as high as 300 dB per kilometer. To traverse this problem, the distance between transceivers of FSO communications links is generally less than 2 kilometers even in clear air. In light fog conditions, a link may only be established or maintained over about 200 meters. In heavy fog, the beam of a 20 meter link is completely extinguished and the link fails entirely. Because attenuation is severe, even the higher power lasers to be developed in the future will not sufficiently overcome the problem. Experts in the field have resigned to the notion that 200 meters is about the maximum link distance and have designed their networks accordingly.

In some applications where it is desirable to transmit an optical beam through atmospheres comprised of scattering elements such as smoke or dense clouds, middle infrared wavelength optical beams have been used. These include military applications of laser radars and other ranging type or imaging systems. Those systems benefit from the well known atmospheric windows, i.e. regions of the spectrum which propagate relatively unimpeded in common atmosphere, however they are highly specialized in their nature. Military applications tend not to be arranged around limited budgets and other constraints found in civilian applications. Some military applications of middle infrared optical systems are well supported with money and space and thus resulting configurations look very different than non-military systems. Military middle infrared systems have been quite successful in demonstrating that optical systems may be deployed in atmospheres which are smoky or otherwise not suitable for visible spectrum transmission.

While one might be inclined to use IR wavelengths which penetrate fog more effectively in commercial FSO systems, the so-called ‘atmospheric windows’around both 5 and 10 microns, this is a difficult proposition. While 10 micron light will propagate nicely through fog, this wavelength is very difficult to detect. Detectors suitable for 10 micron wavelength IR, or Mid-IR, are not very sensitive. Further, they are quite noise making the signal processing systems very complex. To combat the noise, typical IR detectors are operated at hyper-cooled temperature; i.e. cryogenic temperatures. Indeed, liquid cooled IR detectors have been employed in some experimental free space optics applications with limited success. Both IBM and IMT have demonstrated systems where a liquid cooled MCT detector enabled an FSO system resilient to fog. While these detector solutions are workable in laboratories which can support use of cryogenic materials, it is not ‘field deployable’ or useful in normal consumer packages. It becomes desirable therefore, to find an IR detector operable with ‘long wave’ or Mid-IR radiation which does not require a complex cooling apparatus. That is to say, an FSO system having a high (relative) temperature detector would be very useful.

Notwithstanding, techniques and devices have been discovered which provide very novel configurations of optical links, particularly with respect to those which may be used at elevated temperature. In contrast to the good and useful systems of the art, each having certain features that are no less than remarkable, these inventions are concerned with providing highly reliable communications systems, durable against fog, at ambient temperature and without complex cryogenic cooling.

Incorporated Documents

The following documents provide significant background and support for some of the following principles. In particular, certain elements used in combinations taught here are more fully defined and presented in texts cited. Thus, one gains a more complete and full understanding of combinations presented by way of a complete understanding of the elements and how those elements might cooperate with overall objectives of these inventions. A primary element of importance includes special, highly sensitive IR detectors which operate at elevated temperatures.

In the interests of clarity, information contained in those documents is not repeated here. It is recognized that to include that information here would render this disclosure overly cumbersome. However, for completeness, this disclosure incorporates by reference the following documents in their entirety, which bring important description here so that the combinations taught are precisely understood.

Important documents relating to detectors include:

1) J. Piotrowski, M. Grudzien, Z. Nowak, Z. Orman, J. Pawluczyk, M. Romanis, W. Gawron, “Uncooled photovoltaic Hg1 xCdxTe LWIR detectors Proc. SPIE, 4130, 175-184 (2000);

2) J. Piotrowski. “Hg1 xCdxTe Infrared Photodetectors,” in Infrared Photodetectors, 391-494, SPIE, Bellingham (1995);

3) J. Piotrowski, W. Galus and M. Grudzien, “Near Room-Temperature IR Photo-detectors”. Infrared Phys. 31, 1,1-48. (1991);

4) J. Piotrowski, Z. Nowak, M. Grudzien, W. Galus, K. Adamiec, Z. Djuric, V. Jovic, Z. Djinovic. “High capability, quasi closed growth system for isothermal vapour phase epitaxy of(Hg,Cd)Te”. Thin Solid Film, 161, 157 169. (1988);

5) J. Piotrowski, Z. Nowak, J. Antoszewski, C. Musca, J. Dell, and L. Faraone, “A novel multi-heterojunction HgCdTe long-wavelength infrared photovoltaic detector for operation under reduced cooling conditions”, Semicond. Sci. Technol. 13, 1209-1214 (1998);

6) J. Piotrowski and A. Rogalski: “Photoelectromagnetic, magnetoconcentration and Dember infrared detectors”, in Narrow gap II-VI compounds for optoelectronic and electromagnetic applications”. Ed. by P. Capper, Chapman and Hall, 1997;

7) W. L. Wolfe and G. J. Zissis, The Infrared Handbook, ERIM, Ann Arbor (1989);

8) R. A. Wood and N. A. Foss, “Micromachined bolometer arrays achieve low cost imaging,” Laser Focus World, 101-106 (June 1993);

9) R. A. Wood, “Uncooled thermal imaging with monolithic silicon focal planes,” Proc. SPIE 2020 (1993);

10) R. Watton, P. N. J. Dennis, J. P. Gillham, P. A. Manning, M. J. Perkins and M. A. Todd, “IR bolometer arrays the route to uncooled, affordable thermal imaging,” Proc. SPIE 2020 (1993);

11) D. Long and J. L. Schmit, “Mercury-cadmium telluride and closely related alloys,” in Semiconductors and Semimetals, Vol. 5, pp. 175-255, edited by R. K. Willardson and A. C. Beer, Academic Press, New York (1970);

12) R. Dornhaus, G. Nimtz and B. Schlicht, Narrow-Gap Semiconductors, Springer Verlag, Berlin (1983);

13) Properties of Mercury Cadmium Telluride, INSPEC, EMIS Datareviews Series No. 3, edited by J. Brice and P. Capper, IEE, London (1987);

14) A. Rogalski and J. Piotrowski. “Intrinsic infrared detectors,” Prog. Quant. Electr. 12, 87-289 (1988);

15) R. Balcerak and L. Brown, “Mercury cadmium telluride material requirements for infrared systems,” J. Vac. Sci. Technol. B10, 1353-1358 (1991);

16) P. W. Kruse, “The emergence of Hg1 xCdxTe as a modem infrared sensitive material,” in Semiconductors and Semimetals, Vol. 18, pp. 1-20, edited by R. K. Willardson and A. C. Beer, Academic Press, New York (1981); and

17) H. Maier and J. Hesse, “Growth, properties and applications of narrow-gap semiconductors,” in Crystal Growth, Properties and Applications, pp. 145-219, edited by H. C. Freyhardt, Springer Verlag, Berlin (1980).

Documents relating to specialized solid state lasers include:

18) High-speed modulation and free space optical audio/video transmission using quantum cascade lasers; Electronics Letters 1 Feb. 2001. Vol. 37 No. 3

These documents, and each of them, are part of this disclosure.

### SUMMARY OF THESE INVENTIONS

Comes now, James Plante with inventions of Mid-IR free space optical communications systems operable without cryogenic cooling. It is a primary function of these inventions to provide highly reliable communication systems operable in less than favorable conditions which tend to interrupt and attenuate optical beams. In contrast to prior art methods and devices, these systems remain operable over very large link distances, retain high resistance against failure in the presence of contaminants. Further, their detection systems remain functional at ambient temperature or temperatures far higher than predecessor systems which typically require cryogenic cooling at a detector.

In summary, these systems may be described as apparatus for free space communications having a transmitter and a special receiver. The transmitter has an optical source operable for producing beams of LWIR light (from about 3 to about 20 microns) in a time varying signal. The receiver includes an optical detection system with a very special condenser lens intimately coupled to a LWIR photodetector.

Because it is a primary objective of these inventions to provide free space optics communications systems operable in fog, long wave infrared wavelength light beams which have good transmission in atmospheric windows, are used as carriers. However, detection of long wave IR is quite difficult as the sensitivity and complexity of detectors in this spectra are not amenable for the task. Specifically, typical IR detectors are excessively noisy, and thus typically require a very high degree of cooling to improve a signal to noise ratio. In the case where cryogenic cooling is not available, for example in field-deployable FSO systems compared to laboratory systems, another strategy and design must be embraced.

To use LWIR photodetectors at elevated temperatures, it is necessary to find an alternative manner in which to reduce photodetector noise. As the most important source of noise is proportional to detector volume, a reduction in detector volume will produce a corresponding reduction in noise. One can reduce detector volume by reducing its thickness or its cross section or both. The thickness of the detector active region can be reduced with some limitation due to loss as a result of a decreased absorption. In addition, photodetector thickness is chosen with concern towards diffusion length of minority carriers.

Therefore, cross section is left as the parameter for reducing the detector volume. However, it is not immediately clear how one could couple the large diameter input beam necessary in FSO systems having appreciably long link distances to a detector having a very small cross section. Simple lens arrangements are not appropriate for such tasks. Where one wishes to use IR photodetectors at elevated temperatures advanced optical arrangements can be made. These arrangements permit systems with greatly reduced cross section at the detector plane.

An ‘immersion lens’ is a special type of lens which focuses an incoming beam to a small spot cross section in a focal plane. The focal plane of the immersion lens is however inside the lens. That is, the focal plane is immersed in the material from which the lens is made. A detector placed ‘in’ the lens can be very small in cross section and still be exposed to most of the entire beam. Thus, a specialized IR semiconductor detector-immersion lens combination serves well the need for a reduced noise, highly sensitive IR detector which must remain operable without advanced cooling. Accordingly, these inventions are best characterized as IR FSO communications systems operable at elevated temperatures. The FSO receiver detector necessary for high performance at long wavelengths and high temperatures is best described as a photodetector-immersion lens combination. In this way, FSO systems have a far higher performance than competing systems which either work with shorter wavelength carriers, or have complex cryogenic cooling.

Objectives of the Invention

It is a primary object of these inventions to provide free space optical communications links.

It is a further object to provide optical communications links which remain functional in inclement weather.

It is an object of these inventions to provide optical communications links which remain operable at ambient temperatures without complex cooling systems.

A better understanding can be had with reference to detailed description of preferred embodiments and with reference to appended drawings. Some embodiments presented are particular ways to realize the invention and are not inclusive of all ways possible. Therefore, there may exist embodiments that do not deviate from the spirit and scope of this disclosure as set forth by the claims, but do not appear here as specific examples. It will be appreciated that a great plurality of alternative versions are possible.

### BRIEF DESCRIPTION OF THE DRAWING FIGURES

These and other features, aspects, and advantages of the present invention will become better understood with regard to the following description, appended claims and drawings where:

FIG. 1 is an illustration of an optical communications link of these inventions and interaction with atmospheric components;

FIG. 2 is a brief block diagram of communications links of these inventions;

FIG. 3 shows an example of major components of a communications link of a single direction in a schematic diagram;

FIG. 4 illustrates a special photodetector-immersion lens combination of preferred optical receivers;

FIG. 5 includes basic ray traces in these photodetector-immersion lens devices; and

FIG. 6 depicts a special example of an immersed optical semiconductor detector appropriate for some special preferred versions of these inventions.

### GLOSSARY OF SPECIAL TERMS

Throughout this disclosure, reference is made to some terms which may or may not be exactly defined in popular dictionaries as they are defined here. To provide a more precise disclosure, the following terms are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must use the context of use and liberal discretion to arrive at an intended meaning. One will be well advised to error on the side of attaching broader meanings to terms used in order to fully appreciate the depth of the teaching and to understand all the intended variations.

‘Mid-IR’, Middle Infrared, LWIR, Et Cetera

For purposes of these inventions, the Mid-IR portion of the spectrum is meant to include optical wavelengths between about 3 and about 20 microns. With recognition that some writings may suggest different definitions for a ‘Mid-IR’ region of the spectrum, the definition provided is useful for guidance in consideration of the concepts discussed. Sometimes, this same spectrum is referred to as ‘long wave’ infrared or even ‘Far-IR’. Each of these terms hold a rather loose reference to the infrared spectrum greater than a few microns; i.e. to distinguish from the ‘Near-IR’.

Free Space

Although ‘free space’ may seem to imply space free of matter, recent and common use of this term suggests otherwise. Indeed, ‘free space’ as used here is in agreement with definitions where ‘space’ contains at least atmospheric air and perhaps other matter such as fog, haze, hail, snow, rain, dirt, dust, pollution, gases, currents, density gradients, among others. In this definition, ‘free space’ is merely meant to be the absence of optical confinement by waveguides.

Elevated Temperature—High Temperature

While first impressions might lead one to draw conclusions about relative temperature states in view of the terms ‘elevated’ and ‘high’, it is explicitly stated here that ‘elevated’ or ‘high’ temperatures are those which are achievable in systems without complex cooling. For example, while cryogenics and sterling coolers can attain temperatures hundreds of degrees below 0 C, non-cryogenic solid state systems might be able to realize temperatures as low as −100 C or slightly less. Thus, for purposes of this disclosure, ‘high temperature’ or ‘elevated temperature’ means that which can be attained without cryogenics. Accordingly, a detector which operates at −70 C may be said to be a device operating at ‘elevated temperature’.

### PREFERRED EMBODIMENTS OF THE INVENTION

Very special versions of high performance, high ambient temperature, FSO systems are formed of a unique combination of elements. In particular, these systems are comprised of photodetectors having high bandwith and high sensitivity. Further, these same detectors are fashioned to operate without cryogenic cooling. An optical compression or condensing transforms a input beam such that it has a very small footprint or cross section precisely at the photodetector active region. In preferred arrangements, this results is a reduction of the detector area by a factor of up to 100 and a corresponding reduction in detector noise. This optical gain permits operation of these detectors at temperatures far higher than they otherwise would be able to operate due to the excessive noise.

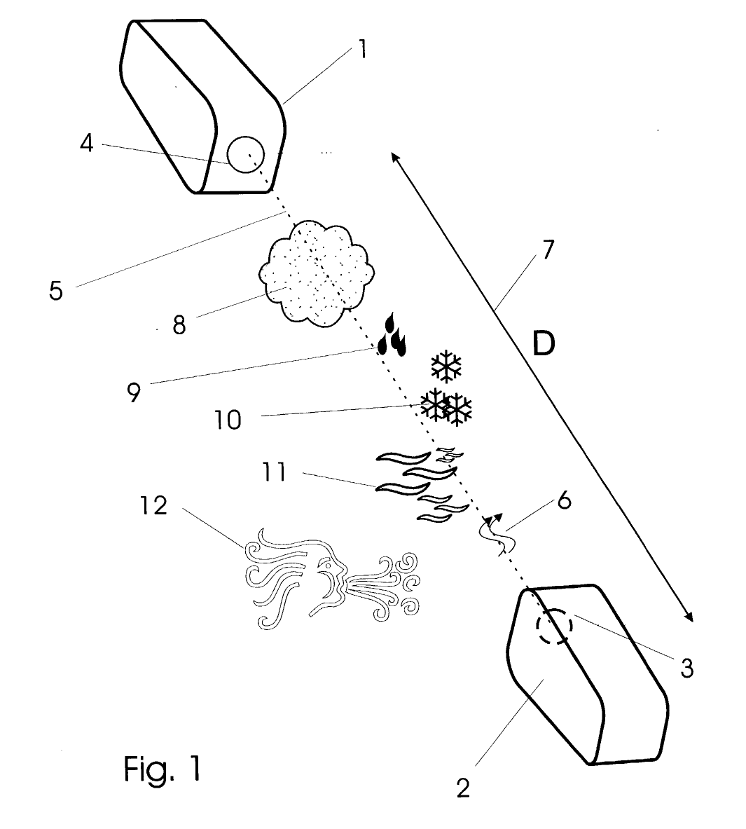

One will gain a firm and complete appreciation for details of these inventions in consideration of drawing figures appended hereto and following descriptions of those figures. With regard to drawing FIG. 1 a generalized perspective block diagram showing major elements of a free space optical communications link highly resistant to interruption by atmospheric components is presented. In particular, a first transceiver 1 is in communication with a second transceiver 2 by way of their optical ports or apertures 3 and 4. More precisely, a free space path along an optical axis 5 accommodates propagation of optical radiation 6 in the form of a light beam generated at either of the transceivers. The path is preferably cylindrical and some preferred versions have circular cross section. The free space path has a discrete length ‘D’ indicated in the figure by numeral 7. Further, the free space path may contain therein components unfriendly to the propagation of optical beams such as fog and water vapor 8, rain 9, snow 10, hail and other matter associated with inclement weather, floating particulate 11 including dust, smoke and pollution, inhomogeneous air currents 12 such as wind, among others.

Transceivers of these inventions are coupled together by a free space transmission medium whereby the path length may be quite long in comparison to systems of the art. Systems of the art employing optical radiation of wavelengths less than 2 microns rarely have optical paths greater than 1 kilometer. At 1 kilometer, those systems are subject to very high failure rates and suffer catastrophic adverse effects from atmospheric attenuation. As a first response, those links using light of less than 2 microns reduce the optical path length and consequently those systems may only support optical paths of two hundred meters or less in highly reliable versions. Accordingly, transmission media of these inventions have the useful property that they are exceptionally long. Despite this length, the system still resists failure due to attenuation in the transmission medium. Under certain circumstances, a link may be established with a transmission media having a path length of tens of kilometers. In conditions accompanied by heavy fog, systems of the invention may support optical paths greater than a kilometer in length and remain fully functional and highly reliable.

A transceiver is included in a first node of a communications link. A second node also includes a transceiver remotely located and separated from the first by free space atmosphere therebetween. Thus, an air column is the transmission medium of an FSO communications link. Just as a glass fiber is the transmission medium of a fiber network and those fibers are characterized and arranged with great consideration for other system components, so are air columns of these inventions. Air columns of these inventions are characterized and arranged in their size and configurations in view of the combinations of other systems elements. The other system elements are also chosen and designed with a view to cooperation with the specific air columns and dynamics of those air columns. Therefore, an air column may be considered an important structural component of an entire system.

These air columns have a structural definition including an axis, a length, a cross section shape and extent, among others. Air columns are also characterized by their composition. Although it is herein called an ‘air column’ it is in fact comprised of far more than just air. Both matter and other physical features should be considered as part of an air column. Physical features such as inhomogeneous distributions of matter, i.e. currents of gases and temperature gradients. Also air columns include matter such as water, dust, et cetera mentioned above. These characteristics and parameters are used to more fully define transmission media of these systems.

Water may be quantified in a density measure such as milligrams per liter. A more common measure is ‘visibility’, having units in distance such as miles. Still further, hazy, light fog, medium fog, heavy fog, et cetera can be used to quantify water content of an air column. ‘Light fog’ can be associated with visibility greater than 2-3 miles. Attenuation of optical beams of 1 micron could be as high as 100 dB/km in ‘light fog’. A beam of 10 micron light however might only suffer an attenuation factor of 10 dB/km in the same light fog. ‘Medium fog’ restricts vision to between about 0.5 to 3 miles. Where medium fog is present, the air contains a moderate amount of water in particulate state; and those particles might have a more appreciable size. A near infrared optical beam of 1 micron might be attenuated at a rate greater than 100 dB/km but still less than 300 dB/km. A middle infrared beam might only suffer attenuation at a rate between 10 dB/km and 30 dB/km. ‘Heavy fog’ results in a visibility of 0 to 0.5 miles. The water content in the air is very high and the particles may be very dense and of a large size. A optical beam of 1 micron wavelength might suffer attenuation greater than 300 dB/km and thus be near completely extinguished in a very short distance. While in heavy fog, light of 10 microns might only be attenuated at a rate of 30 to 80 dB/km or in extreme cases about 100 dB/km. Thus, in heavy fog, a Mid-IR optical beam may still be used to form a useful communications link.

These characterizations are presented to project a qualitative feeling as to fog and its effects on light. Because fog is very different from place-to-place, and in various temperature states, and humidity conditions, the numbers above are not intended as an absolute measure of ‘visibility’, ‘fog’, or ‘attenuation’.

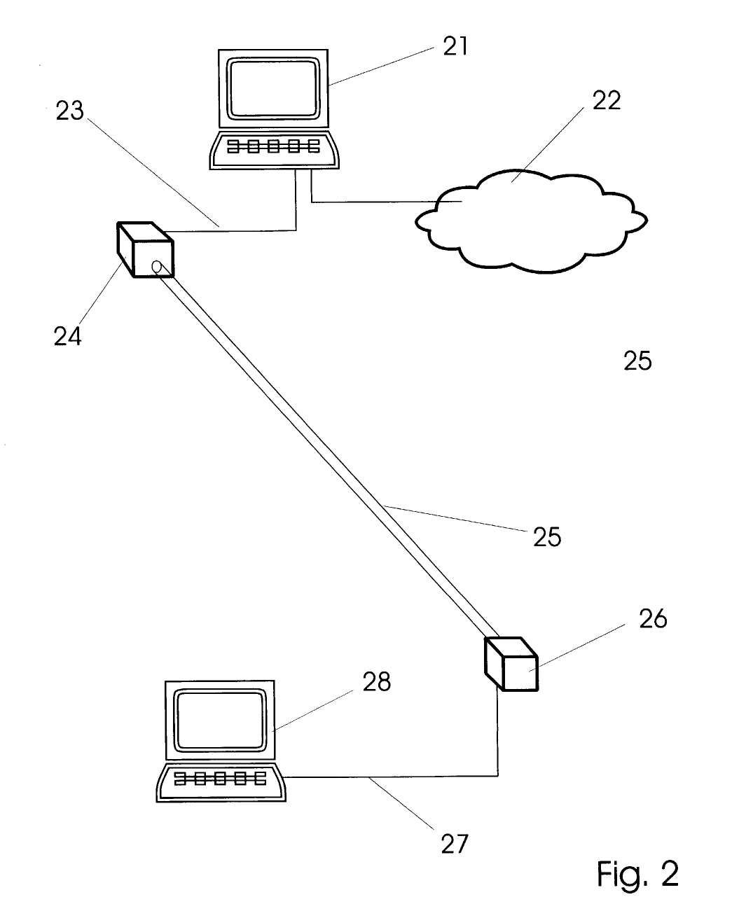

To more fully understand communications links of these inventions, it is useful to see how they might be embodied in common application. FIG. 2 is a diagram showing a host computer 21 in high speed communication with an Internet 22 network of computers. The host may further be in electronic communication 23 with an FSO communications link. A first transceiver 24 communicates over an air column 25 with a second transceiver 26. That transceiver having a connection 27 to a client computer 28 completes the connection allowing a user direct and high speed access to any computer on the Internet.

To more clearly understand how such an FSO communications link conveys information from one point to another, one should consider the links individual components and elements. With regard to a single direction only, i.e. most systems are bi-directional but for clarity in this description, a system is simplified to a single direction. In bi-directional systems, an identical arrangement in a reciprocal direction is provided for a return link.

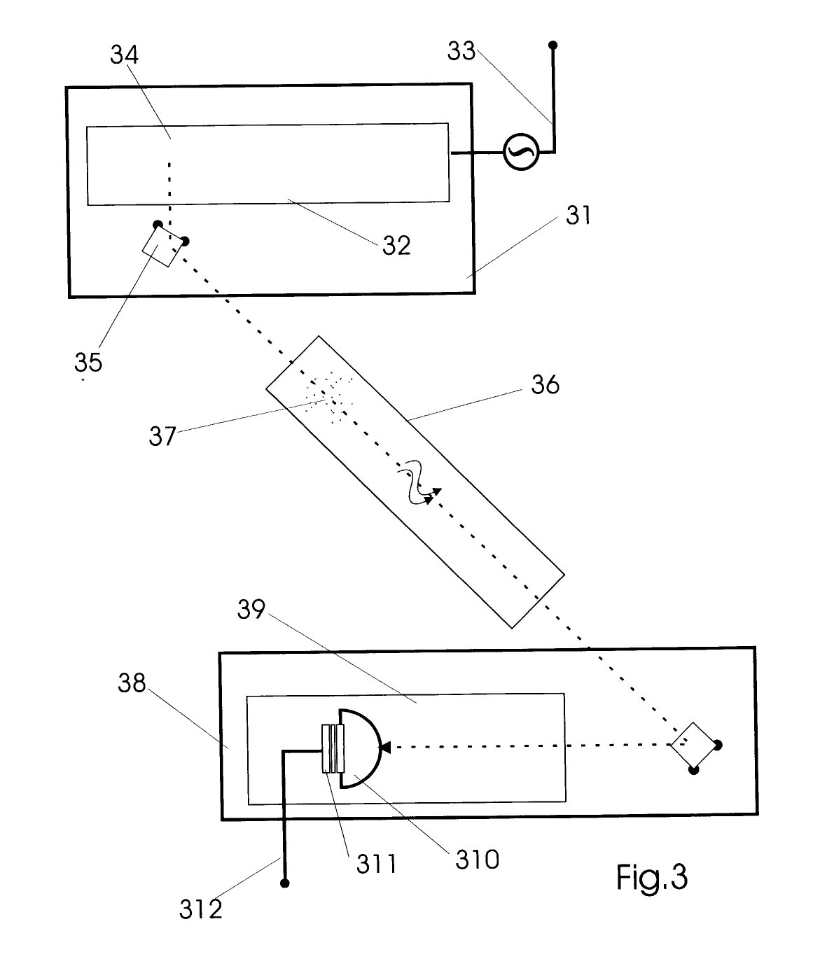

A more complete understanding of a preferred arrangement of elements of a communications link is shown in the drawing of FIG. 3 which illustrates the single direction link. A transceiver 31 includes a transmitter portion 32 which receives input data signals from data line 33 and encodes those electronic signals into a modulated optical signal at optical source 34. Optical beams produced in the transmitter may be coupled to a steering mirror 35 where the beam in launched into a transmission path 36. The transmission path or transmission medium may include water vapor 37 among other contaminants. Finally, a second transceiver 38 includes an optical detection system portion 39. A highly specialized detector comprising an immersion lens 310 condenses incident light and directly couples it to a special layer in a HgCdTe, or MCT, type photodetector 311. By way of amplifier electronics, an electrical signal corresponding to the modulated beam and thus a digital input, is presented at electrical output 312.

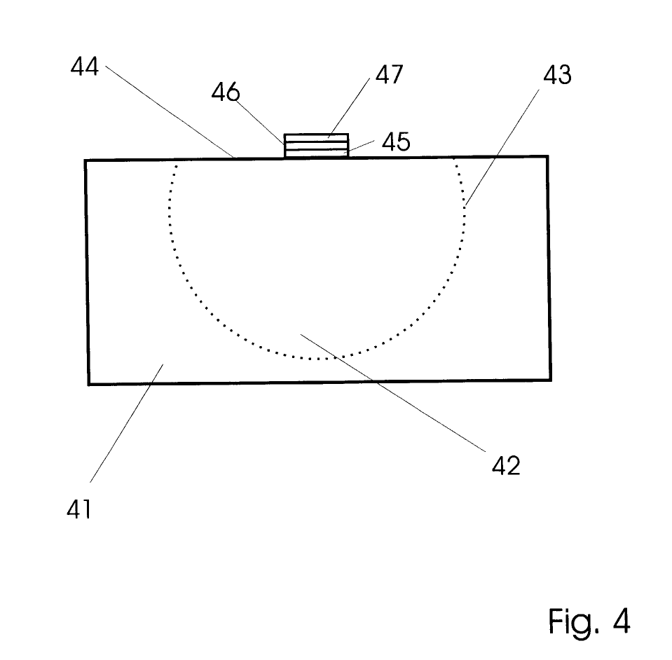

FIG. 4 illustrates further detail with regard to certain specific optical transducers which may be used in optical detection systems of preferred embodiments. A substrate 41 of semiconductor material, for example Gallium Arsenide, is basis from which a lens 42 may be formed. The substrate may be processed in a grinding operation to form a optical element having at least one spherical section surface. Dotted line 43 indicates a preferred optical geometry between a lens and photodetector. Besides the resulting spherical section surface, the substrate additionally has a planar surface 44. That planar surface may intersect normally any radial line between the spheres center and the sphere surface. This configuration sometimes referred to as hyper-hemispherical assures good coupling from incident light beams with regard to the detector which is formed directly upon the planar surface in epitaxial processes. Some preferred detectors are characterized as photodiodes having three layers as follows: an active region layer 46 lying between two connection layers.

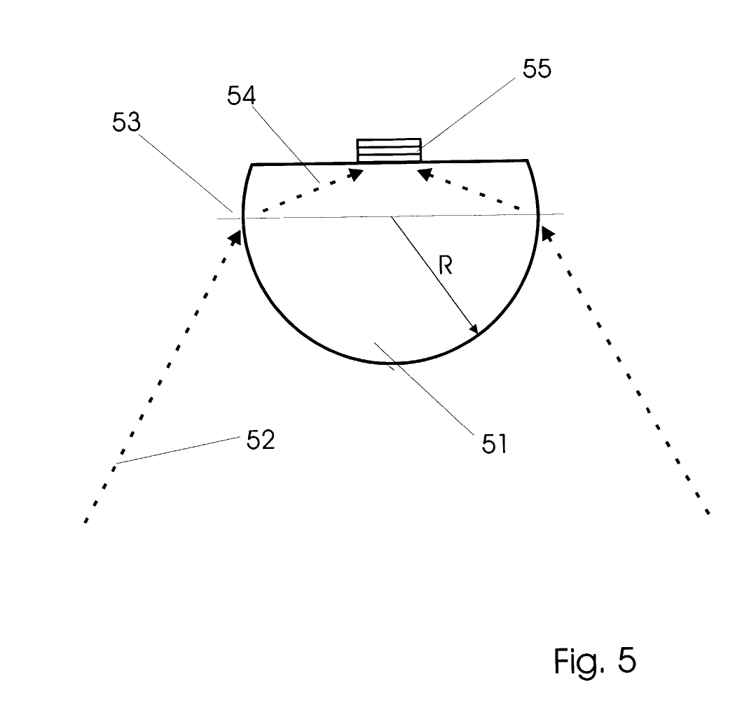

To demonstrate the condensing properties of an immersion lens, ray trace diagram of FIG. 5 is provided. Lens 51 assures that light 52 converging and focused onto the device refracts at lens spherical surface 53 and is directed 54 towards semiconductor detector 55. The presented photodetector 55 has a very small cross sectional area. This allows operation of the device at warm temperatures without excess noise. As shown in the figure, the relationship between the lens and the photodetector is known as hyper-hemispherical.

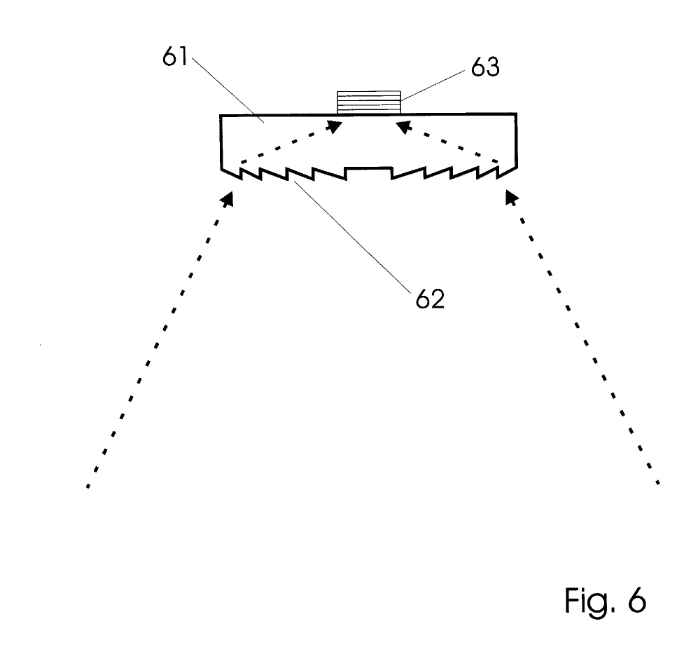

While lenses having spherical surfaces are most generally preferred for use as immersion lenses, it is not necessary that an immersion lens be a spherical device. An alternative immersion lens of great interest is a Fresnel diffractive lens. A surface relief pattern may be cut or etched into a semiconductor substrate to effect such lens action at the surface. It is well know that a very high numeric aperture can be attained with these lenses. The numeric aperture being limited only be the finesse in which the surface relief pattern can be formed. FIG. 6 illustrates. A substrate has been etched to cause a pattern on one surface 62. The detector 63 being disposed on the opposite substrate surface is in a position which strongly couples it to incoming light. Further alternatives suggest that kinoform may also be applied to a surface rather than a relief pattern to effect a diffraction type lens. Holographic layers also may be formed on the surface of a semiconductor substrate to bring about still further another diffractive alternative.

With the previous basic description as foundation, these inventions are more fully understood with details relating to individual elements including particularly detector subsystems. Thus, a transceiver is more fully presented by way of its receiver and optical detection means as follows.

Receiver

Receivers include at least the following elements: an optical condenser lens, an photodetector transducer and an electrical output. These lens/photodetectors are comprised of very special arrangements of semiconductor materials and optical elements. The detector may be coupled to an electrical output such that optical signals received by a receiver are converted to digital electrical signals which may be passed into downstream cooperating systems. In preferred versions, a remarkable single crystal device forms both an optical element and an electronic transducer element.

Detectors

The reader is asked to recall that these FSO systems preferably are arranged without cryogenically cooled support apparatus as they are designed to be deployed in field applications where low maintenance is a necessity. Accordingly, a primary feature of these unique detectors is that they must operate in temperatures attainable without complex cryogenic cooling systems. Further, they must operate to detect Mid-IR radiation; i.e. they are responsive in the middle infrared spectral region. Further they must be exceptionally fast to provide for high bandwidth signals. Finally, they must be highly sensitive to assure a sufficient system link margin.

Detection science relating to infrared radiation is certainly not new. However, almost without exception, infrared detectors are operated in a highly cooled state. The most common of these types of devices include the HgCdTe type semiconductor photodetectors. When one attempts to use a common HgCdTe detector at elevated temperatures, the device loses efficacy and is quickly overcome by noise. Accordingly, very special arrangements of semiconductor layers purposefully selected for high temperature operation are necessary. A HgCdTe detector designed for cryogenically cooled systems cannot be used effectively in this systems.

These photodetectors may also be of various configurations to achieve additional behavior. For example, where it is desirable that the detector have internal gain, a phototransistor type semiconductor stack and bias arrangement can be used. A common photodiode arrangement is also possible in preferred versions. Especially photodiodes having special noise reduction schemes like Auger noise suppression. Further, photovoltaics may be prepared for operation at elevated temperatures in conjunction with an immersion lens suitable for coupling to as FSO receiver.

Immersion Lens

Because operation of HgCdTe at elevated temperatures is inherently noisy, one must apply best measures including advance optical gain techniques to assure a firm noise reduction strategy. In cooled HgCdTe applications where noise is reduced because generation and recombination from thermal effects is slight, it is not necessary to employ special optical gain mechanisms.

In review, noise is generated primarily because of thermal processes which cause generation and recombination of carriers. In a cooled state, these thermal processes become insignificant. However, in warm applications these is considerable noise due to thermal activity; special measures are to be taken. One important step includes providing a detector with a minimal volume of detector material. Where cooled detectors may be quite large in volume, warm detectors must be small as possible. This demands very thin layers and more importantly very small cross sections. To better couple light from the FSO input beam into the detector active region, a special trick may be applied. A condenser lens of the immersion type helps to concentrate optical input and allows a smaller volume detector and corresponding reduction in noise. To provide such arrangement, a multi-layer detector may be formed onto a bulk crystal substrate. After the detector is formed, the substrate is then ground into the shape of a lens. Light entering the lens is refracted towards the small detector volume. Thus the optical footprint is quite large, while the actual detector volume is significantly reduced. An immersion lens combined with a detector in this way is unlike other lenses because the light does not leave the lens medium but rather its propagation is terminated while the light is still in the material from which the lens is formed. Because a very useful lens, i.e. a lens having good transmission properties in view of Mid-IR light, can be formed from material having the same crystal configuration as the HgCdTe detector, i.e. a CdTe lens or a GaAs lens, the HgCdTe detector is built onto a substrate formed of these materials and the substrate is thereafter ground into a lens which forms the immersion lens relationship with the detector element. This is rather remarkable as it causes the lens and the detector to be a single crystal element. While such arrangements may suffer from significant crystal mismatches between some layer interfaces, steps may be taken to alive this. For example, a very thin buffer layer of doped material which mediates the crystal lattice properties between the two stressed layers is possible. Further, layers having doping applied in a gradient manner could form a doping strategy for a buffer layer.

It is not necessary, nor desirable, to form immersion lenses onto cooled detectors.

Now, many optical experts in practice prior to this disclosure have applied immersion lenses to general optical systems to realize an optical gain. However, it is the special cooperation between FSO systems which demand warm detector operation and the nature HgCdTe which necessarily is in a low volume format to maintain operability in elevated temperatures, in further view of the FSO transmission media length and carrier wavelength. Each of these parameters demand the configuration of the immersion lens/photodetector be just so.

Accordingly, a complete system of these invention can generally be specified as an apparatus for free space communications having a transmitter and a receiver. That transmitter including an optical source for producing infrared beams in time varying signals; that receiver having an optical detection subsystem including a condenser lens coupled to an IR photodetector. Further, that the condenser lens is an immersion type lens having a photodetector intimately coupled with the lens medium. In best versions, the detector and planar surface of the lens form a hyper-hemispherical relationship with the lensing surface. Alternatively, the lens may be a Fresnel type diffractive lens.

These immersion lenses may be made from materials classified as a III-V group material such as Gallium Arsenide or alternatively a II-VI group material Cadmium Telluride.

Detector materials are similarly II-VI group materials and more specifically HgCdTe compositions characterized as having a narrow bandgap. This may be realized with HgCdTe which is further specified as Hg₍₁₋ₓ₎Cd₍ₓ₎Te, where the value of x is between 0.15 and 0.18. As such, these photodetectors are operable at temperatures greater than −70 C. This is partly due to the fact that these photodetectors have low volume active areas in comparison to common HgCdTe detectors. To reach low volume, photodetector active regions have a thickness less than 10 microns and a cross section of less than one millimeter in preferred devices. Thus, preferred immersion lens detectors of these inventions include those having a diameter less than a few millimeters. Some preferred versions have a lens radius just 1 millimeter or even sub-millimeter.

These photodetectors may be photodiodes, photodiodes with an Auger noise suppression mechanism; photoconductors, photoconductors with low dark current; or phototransistors, phototransistors with active gain mechanisms.

These photodetectors are bound to the lenses by crystalline lattice forces as the photodetectors formed on a planar lens surface in an epitaxial process. In some versions, the photodetector-lens has a buffer layer to relieve mechanical stress due to crystal mismatch.

The lens-photodetector are optically coupled whereby light incident upon the lens surface is strongly coupled to an active region of said photodetector and may be characterized as hyper-hemispherical.

An optical detection system may also include means for applying electrical bias to said photodetector. An optical detection system further comprises optical mounting to couple optical detection system with said receiver and transmitter. An optical detection system further comprises an electronic preamp integrated with said photodetector structures. In some versions, an optical detection system further comprises cooling system such as a Peltier type solid state cooling apparatus without moving parts.

One will now fully appreciate how a high performance, field deployable free space optics communication system can provide tremendous advantage for conveying information in an atmosphere otherwise unsuitable for optical transmissions. Although present inventions have been described in considerable detail with clear and concise language and with reference to certain preferred versions thereof including best modes anticipated by the inventor, other versions are possible. Therefore, the spirit and scope of the invention should not be limited by the description of the preferred versions contained therein, but rather by the claims appended hereto.

What is claimed is:

1) Apparatus for free space communications comprising a transmitter and a receiver, the transmitter comprising an optical source operable for producing beams of LWIR light in a time varying signal, the receiver comprising an optical detection system including a condenser lens coupled to an LWIR photodetector.

2) Apparatus of claim 1, said condenser lens is immersion type lens whereby said photodetector lies ‘inside’ the lens medium in the optical sense.

3) Apparatus of claim 2, said immersion lens comprises a substantially planar surface, said photodetector is disposed thereon said planar surface.

4) Apparatus of claim 3, said immersion lens further comprises a spherical section refractive surface.

5) Apparatus of claim 4, lens, detector and planar surface form a hyper-hemispherical relationship.

6) Apparatus of claim 3, said lens is Fresnel type diffractive lens.

7) Apparatus of claim 6, said Fresnel type lens is characterized as one having surface relief pattern.

8) Apparatus of claim 6, said Fresnel type lens is characterized as one having kinoform pattern thereon a top surface.

9) Apparatus of claim 2, said lens is comprised of material characterized as a III-V group material.

10) Apparatus of claim 9, said material is Gallium Arsenide.

11) Apparatus of claim 2, said lens is comprised of material characterized as a II-VI group material.

12) Apparatus of claim 11, said material is Cadmium Telluride.
Photodetector

13) Apparatus of claim 1, said photodetector is operable for detection of light characterized as ‘long wave infrared’, LWIR.

14) Apparatus of claim 13, said photodetector is comprised of semiconductor material whos composition may be characterized as having a narrow bandgap.

15) Apparatus of claim 14, said said semiconductor material is a Mercury-Cadmium-Telluride material.

16) Apparatus of claim 13, said photodetector is operable at temperatures greater than −70 C.

17) Apparatus of claim 13, said photodetector has low volume active area.

18) Apparatus of claim 17, said photodetector has thickness less than 10 microns and a cross section of less than one millimeter.

19) Apparatus of claim 13, said photodetector is a photodiode.

20) Apparatus of claim 19, said photodiode additionally comprises an Auger noise suppression mechanism.

21) Apparatus of claim 13, said photodetector is a photoconductor.

22) Apparatus of claim 21, said photoconductor further defined as . . . ???

23) Apparatus of claim 13, said photodetector is a phototransistor.

24) Apparatus of claim 23, said phototransistor is further defined as having internal gain.
Lens-Detector Coupling

25) Apparatus of claim 1, said photodetector is bound to said lens by crystalline lattice forces.

26) Apparatus of claim 25, said photodetector is a semiconductor formed on a planar lens surface.

27) Apparatus of claim 26, said photodetector is formed in epitaxial process.

28) Apparatus of claim 25, said photodetector and said lens have a buffer layer there between whereby mechanical stress due to crystal mismatch is reduced.

29) Apparatus of claim 26, said lens and said photodetector are optically coupled whereby light incident upon the lens surface is strongly coupled to an active region of said photodetector.

30) Apparatus of claim 29, said optical coupling is characterized as hyper-hemispherical.
Other

31) Apparatus of claim 1, said optical detection system further comprises means for applying electrical bias to said photodetector.

32) Apparatus of claim 1, said optical detection system further comprises optical mounting to couple optical detection system with said receiver and transmitter.

33) Apparatus of claim 1, said optical detection system further comprises an electronic preamp integrated with said photodetector.

34) Apparatus of claim 1, said optical detection system further comprises cooling system.

35) Apparatus of claim 34, said cooling system is characterized as a highly reliable solid state cooling apparatus without moving parts.
Restatement

36) Optical communications systems for conveying encoded information comprising a plurality of nodes, at least one node comprising a transmitter and at least one node comprising a receiver, said nodes each having an optic axis aligned with the optic axis of another node whereby a transmitter is coupled to a receiver by optical beams arranged to propagate therebetween said nodes, said transmitter operable for providing an encoded optical beam characterized as middle infrared optical radiation, said receiver operable at temperatures greater than −70 C.

37) Systems of claim 1, said receiver comprising a semiconductor photodetector characterized as being comprised of a II-VI material.

38) Systems of claim 2, said II-VI material is further characterized as having a narrow bandgap.

39) Systems of claim 2, said II-VI material is further defined as HgCdTe.

40) Systems of claim 4, said HgCdTe is further specified as
Hg₍₁₋ₓ₎Cd₍ₓ₎Te,
where the value of x is between 0.15 and 0.18.
